(19) United States
(12) Patent Application Publication
(10) Pub. No.: US 2008/0031447 A1
(43) Pub. Date: Feb. 7, 2008

(54) SYSTEMS AND METHODS FOR AGGREGATION OF ACCESS TO NETWORK PRODUCTS AND SERVICES

(76) Inventors: Frank Geshwind, Madison, CT (US); Eileen McCarthy, Madison, CT (US); Edward F. McCarthy, Chelmsford, MA (US)

Correspondence Address: Frank Geshwind, Shoreline Tech, 61 Wellsweep Drive, Madison, CT, 06443, US

(21) Appl. No.: 11/833,979

(22) Filed: Aug. 4, 2007

Related U.S. Application Data
(60) Provisional application No. 60/835,723, filed on Aug. 4, 2006.

(51) Int. Cl. H04L 9/22; G06F 17/00; H04L 9/28; H04L 9/32; G06F 7/58

(52) U.S. Cl. 380/46; 380/28; 705/1; 713/168; 726/12

(57) ABSTRACT

The present invention is directed to a method and computer system for access aggregation comprising the storage and retrieval of website userids and passwords, and potentially other information, which is secure and convenient and automates access to the variety of websites of interest to users, and to the other information. An embodiment comprises a web server with web pages and files including client application code and server code, databases, and other components, to store encrypted versions of the userid and password for the user to login to the various sites for which the user is a member. The encryption/decryption key(s) to encrypt/decrypt the userids and passwords are never sent to the server and are only present on the client, so that the method is secure. The invention optionally additionally provides an interface allowing a user to manage various accounts, ids, passwords and other information.

### RELATED APPLICATION

This application claims priority benefit under Title 35 U.S.C. § 119(e) of provisional patent application No. 60/835,723, filed Aug. 4, 2006, which is incorporated by reference in its entirety.

### BACKGROUND OF THE INVENTION

The present invention relates to systems and methods for access aggregation and automated authentication of users for use of and access to network products and services, and to the determination of revenue derived from such. The invention more particularly relates to systems and methods for automated authentication of users on network sites, products and services, such as Internet websites, so that users may use and access such products and services. The invention additionally relates to the determination of revenue derived from interactions and use involving and/or following such access.

### FIELD OF THE INVENTION

The process of using websites presently often requires users to enter userid and password information in order to gain access to the website(s). This creates an immediate problem for the users, and to some extent a problem for the websites: users need to create, manage and remember this plethora of data comprising their lists of websites, userids and passwords. When users loose or forget their login information for a particular web site, they may be unable to access the site, or may need to go through a moderately or generally difficult process to reconstruct their account information. This has disadvantages to the user including but not limited to wasted time and effort; in some cases loss of information or value. There is a corresponding disadvantage to the website owners. User attrition, wasted time and wasted bandwidth can all result from users forgetting ids and passwords—many users will simply fail to return to the site, or give up, not wanting to go through the annoyance of resetting passwords, etc. This can cause lost business for the website, and lost revenue.

FIG. 1 displays the current process of access to websites. The user first selects a web site in step 100. The user proceeds to step 110 by locating and entering the Internet address of the selected website. This step may be accomplished in several manners with varying levels of complexity. A simple means for accomplishing this step is the utilization of a bookmark or favorite whereas locating a website for the first time might involve significant time and effort performing online searches. In step 120, the user logs into the selected website utilizing the site's specific logon protocol. This protocol typically involves verifying the identity of the end user using a user name or user identification, (herein a userid) and password or other means of verification, acquiring the verification data from cookies residing on the end user's system or a combination of requested data and cookie data. The user is then granted access to the site. Under this access model, the user must visit each separate information provider, track potentially different identity verification data for each, and utilize a different user interface at each site.

Users and prior art systems may try to cope with this problem in various ways. The users may try to remember the passwords. This has the disadvantage that the users may forget the information. Users sometimes attempt to use the same userid and password on all websites (or to have a very small set of userids and passwords, and reuse them or mild variants of one or a few). This is not secure in that a malicious operator of a site can spy on userids and passwords, and attempt to use this information to gain access to the user's other websites. Also, many sites have security requirements on passwords, requiring them to be of predetermined lengths, or to satisfy other predetermined rules such as but not limited to requiring numerical and/or punctuation symbols in the passwords and/or requiring that the passwords be changed on a regular basis. For this reason, users can't always use the same password, and the problem of remembering the variations resurfaces.

Users may keep a written or electronic list of websites, userids and password. This has disadvantages such as the fact that the users can loose the list, may not have it with them at all times, and may inadvertently allow others to access the list, resulting in a security risk. Some web browsers and third party applications allow users to semi-automatically store website userids and passwords. For example, the Netscape Navigator browser and the Microsoft Internet Explorer browser both have these features built in. These have the disadvantages cited. While these electronic lists can be and typically are encrypted or protected by security measures, the level of security is often such that a hacker can still gain access to this information. Recently, secure devices, including but not limited to USB “thumb” devices, have been created that can securely store passwords, account and other information. These still suffer from the fact that users can loose them, or not remember to carry them at all times.

Certain systems exist for the online storage of personal information and personal-information-access data (see, for example, U.S. Pat. No. 6,871,220). The online storage of such information solves some of the problems just described. However, among the disadvantages of these latter systems are the security dangers—if a hacker were to gain access to the database of a company practicing U.S. Pat. No. 6,871,220, the hacker would simultaneously have access to personal, financial and/or other information about a potentially large base of users. Also, U.S. Pat. No. 6,871,220 is directed towards access to Personal Information stored within Personal Information Provider Networks, while there is a need for a system directed to the access to websites and network information generally. As an example of the distinction, many websites, such as nytimes.com, require userid and password information simply to access the articles published daily on the site. While these are not generally “personal information”, users still would benefit from convenient and automated access to the site without the need to remember userids and passwords. This distinction is not merely semantic—convenient access to websites is not the same as the “deep linking” process often involved in the kind of personal information access described in U.S. Pat. No. 6,871,220.

Certain other services exist, such as the website http://del.icio.us, which assist users in centrally storing annotated lists of websites. However, these services do not deal with the issue of user authentication addressed herein.

The Password Generator Bookmarklet, presently available at the web URL http://www.angel.net/˜nic/passwdlet.html, is an example of a prior art web program for automatic generation of passwords from a master password. This differs from the present invention in many ways, including but not limited to the fact that a user needs access to the bookmarklet in order to access the accounts, and no information is stored on a server to assist in the process. If a password generator bookmarklet user's master password were compromised, access to all sites would be possible without any further need for access to data. With the present invention, in some embodiments, a user's master password is needed, together with access to a user's account on a secure server.

Users often have a variety of other pieces of information that would be of use in a variety of situations, but for which access to these data presently require the use of brain power or human memory, the carrying of cards or lists, PDAs, or other ad hoc systems of recording and accessing the information. The present invention can also be used advantageously in order to remember and globally access information including but not limited to medical insurance IDs/numbers, other insurance numbers, frequent flyer numbers, phone numbers, and the like.

Hence there is a need for an improved system for the storage and retrieval of website userids and passwords and potentially other information, which is secure and convenient and automates access to the variety of websites of interest to users, and to the other information.

In other and related aspects of the field and the invention, access to websites and Internet products and services involves not only userids and passwords but also generally the management of: authentication, individual identities, group identities, entity and website identities, accounts and destinations, networks and connections. At various times it is necessary to identify a user, identify a website, authenticate either of those, manage userids, passwords, accounts and memberships, rights and privileges to access locations and data. Network and connection management comprises such tasks as the management and use of dialup, cable, dsl, dedicated line and VPN network connections. The methods and systems disclosed herein, in part, relate also to these aspects of access aggregation by providing ways for users to manage connections, networks, accounts, authentication and identification.

Users may wish to have more than one “identity”—for example a professional identity and a personal identity, in which, for example, web accounts and memberships are stored separately. For example, a stock market analyst who is also a baseball fan and an avid bicyclist may wish to manage website accounts, etc, separately for these different “persona”. The methods and systems disclosed herein, in part, relate also to this aspect of access aggregation by providing ways for users to manage identities. In these regards, management comprises provisioning, setting, updating, keeping secure, remembering, re-setting and keep secret, each when and where relevant.

Hence, in this aspect, there is a need for an improved system for the management and aggregation of access.

Various other objects, advantages and features of the present invention will become readily apparent from the ensuing detailed description, and the novel features will be particularly pointed out in the appended claims.

### OBJECT AND SUMMARY

The present invention is a system and method for automated access to websites and other information associated with a user. It is an object of the present invention to provide improved systems for the storage and retrieval of website userids and passwords, and other information, which is secure and convenient and automates access to the variety of websites of interest to users, and to the other information.

An embodiment in accordance with the present invention comprises a web site for the accomplishment of the objects of the invention described herein. More particularly, in accordance with an embodiment of the present invention, a web site comprises a web server with web pages and files including client application code and server code, databases, and other components, each as described herein and additionally comprising those necessary and standard elements of a web server, known to those of skill in the art.

The website and database store encrypted versions of the userid and password for the user to login to the various sites for which the user is a member.

In an embodiment of the present invention, the encryption/decryption key(s) to encrypt/decrypt the userids and passwords, are never sent to, used or stored on the server and are only present on the client. In this way a security compromise of the server does not imply a compromise of the full database of userids and passwords.

In an embodiment of the present invention, the client application additionally provides an interface allowing a user to manage various accounts by sorting them, arranging them according to use, pre-defined or user-defined categories, and closing accounts.

It is an object of the present invention to provide methods and systems for access aggregation services comprising the management of: authentication, individual identities, group identities, entity and website identities, accounts and destinations, networks and connections by providing ways for users to manage connections, networks, accounts, authentication identities and identification, etc, as disclosed herein.

It is an object of the present invention to provide a computer based method for authentication of a user of products and services over a network. The authentication comprises a first userid and a first password. This is accomplished by the steps of accepting a master userid and master password from the user, creating an encryption key from the master userid and the master password, receiving the fist userid and the first password, encrypting the first userid and first password using the encryption key, to produce encrypted information, sending the encrypted information to a server for storage. Later the encrypted information is retrieved from the server, decrypted, and the user is authenticated with the result.

It is an object of the present invention to automatically retrieve userids and passwords from data entered into an authentication web form, thereby providing an automated system not requiring an extra step for the user.

It is an object of the present invention to automatically insert userids and passwords into an authentication web form, thereby providing an automated system not requiring an extra step for the user.

It is an object of the present invention to create an encryption key from a master userid and a master password using a hash function.

It is an object of the present invention to create an encryption key from a master userid and a master password by generating a pseudo-random prime number.

It is an object of the present invention to provide a browser plugin comprising a client application and thereby disposed to automatically authenticate a user.

It is an object of the present invention to provide a web proxy comprising a client application and thereby disposed to automatically authenticate a user.

It is an object of the present invention to provide a modem comprising a client application and thereby disposed to automatically authenticate a user.

It is an object of the present invention to provide a browser in a browser software component as described herein and comprising a client application and thereby disposed to automatically authenticate a user.

It is an object of the present invention to provide a periodically executed function that checks for authentication requests, thereby providing an automated system not requiring an extra step for the user.

It is an object of the present invention to provide a user with a set of membership accounts to websites. This is accomplished by receiving information about the user, receiving information about a collection of websites, comparing the information about the user to the information about the websites to produce a score for each website, selecting a set of websites with the highest scores, creating a membership account comprising authentication information for the user to access each website, encrypting the authentication information to produce encrypted authentication information, and sending the encrypted authentication information to a server for storage and later retrieval.

It is an object of the present invention to provide a way to receive bids for amounts to be paid for placement of websites in these kinds of provisioning lists.

The above and other objects and advantages of the present invention will become more readily apparent when reference is made to the following description, taken in conjunction with the accompanying drawings.

### BRIEF DESCRIPTION OF THE DRAWINGS

For a more complete understanding of the present invention, reference is now made to the following descriptions taken in conjunction with the accompanying drawing, in which:

FIG. 1 depicts an embodiment in accordance with the prior art.

FIG. 2 shows a block diagram of an embodiment of the present invention.

FIG. 3 shows a block diagram of an embodiment of the present invention.

FIG. 4 shows a block diagram of an embodiment of the present invention.

FIG. 5 shows a block diagram of an embodiment of the present invention.

FIG. 6 shows a flowchart of some functions comprising an embodiment of the present invention.

FIG. 7 shows a flowchart of some functions comprising an embodiment of the present invention.

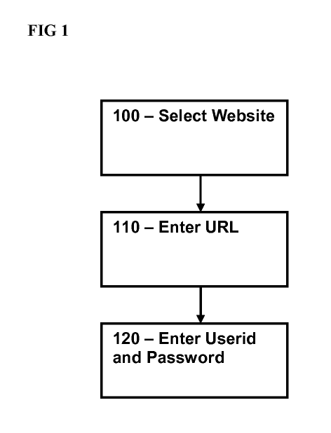

### DETAILED DESCRIPTION OF THE EMBODIMENTS

An embodiment of the invention is now described in detail. Referring to the drawings, like numbers indicate like parts throughout the views. As used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise.

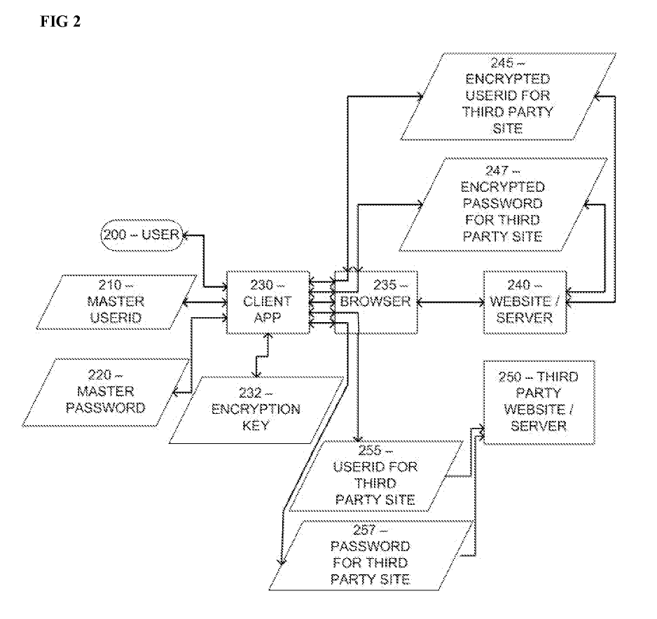

Referring to FIG. 2, in an embodiment of the present invention, a user (200) possesses a master userid (210), a master password (220), and an account on a website (240). The website (240) runs the server application program in accordance with an embodiment of the present invention. In the course of using a third party website (250), the user (200) creates and account on the website (250). The creation of this account comprises the generation of a userid (255) and a password (257) for the website (250). Through the use of a client application (230) running on the user's computer in accordance with an embodiment of the present invention, the userid (255) and password (257) are encrypted with a key (232) generated from the master userid (210) and the master password (220), to make and encrypted userid (245) and encrypted password (247) corresponding respectively to the third part website's (250)'s userid (255) and password (257). The client application (230) makes a request to store the encrypted userid (245) and encrypted password (247) on a server programmed in accordance with an embodiment of the present invention, at the website (240). The encrypted userid (245) and encrypted password (247) are stored and associated with the site (250), on the server (240). Later, when the user returns to the website (250), the client application (230) requests the encrypted userid (245) and encrypted password (247) from the server (240). The encrypted userid (245) and encrypted password (247) are returned from the server (240) to the client (230). The client application (230) decrypts these data to reconstruct the userid (255) and password (257) for the website (250), and uses these to login to the website (250) without the user having to type (or even remember) the userid (255) or password (257) for the website (250). It is to be understood that in an embodiment the encrypted userid (245) and encrypted password (247) may be handled as separate data items as described, or they may be combined into a single bitstream that can be decoded into the pair comprising the userid (255), and the password (257).

In an embodiment the user obtains an account on the server/website (240) by visiting a webpage on the server/website (240), and signing up for such an account.

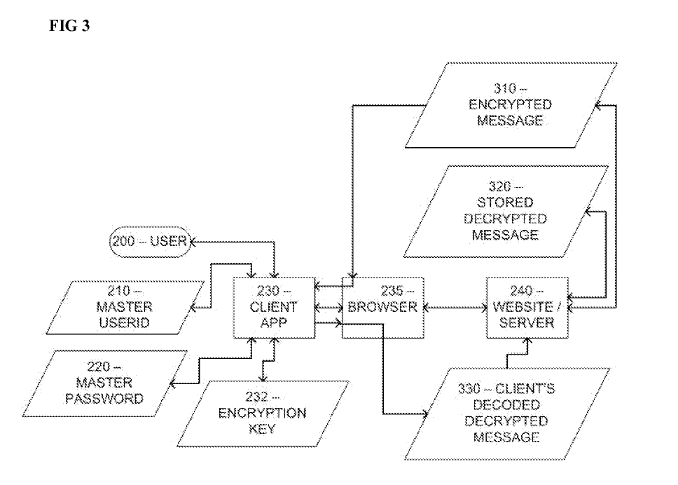

Referring to FIG. 3, an embodiment in which the user accesses a server site (240) by means of a client application (230) running on the user's computer, using a userid (210) and a password (220) comprises the following steps. In accordance with an embodiment of the present invention, the server (240) has elements comprised of a database, the database comprised of an encrypted message (310), having been previously encrypted with a key (232) not present on the server, in accordance with the present invention. The database further comprises a decrypted message (320), with this decrypted message (320) being a decrypted version of the encrypted message (310). It is to be understood that the message (310) is to have been generated by the client application (230) at a prior time—initially when the user creates his account on the server website (240), and then later, from time to time, replaced with new messages (310) as described herein. When the message (310) is created, it is encrypted by the client application (230) with a key (232) generated from the master userid (210) and the master password (220) so that the client application (230) can later decode the message (310) to reconstruct the message (320) in accordance with the present invention. In order to log in to the server website (240), the client application (230) sends a request to the server (240) to log in or authenticate the user with the userid (210). The server retrieves from its database the message (310) associated with the userid (210), and sends the message (310) to the client (230). The client application (230) decodes the message (310) as described, to produce a decoded message (330), and sends the decoded message (330) to the server (240). The server (240) compares the received message (330) with the stored decoded message (320). If the messages (330) and (320) are the same the user is authenticated and access to the server (240) proceeds as described herein, otherwise a failure response is sent back from the server (240) to the client application (230) and the user is informed by the client application (230) that authentication has failed and that the user should check his password and try again. In the case that the user is authenticated, the server (240) can optionally choose a new stored decoded message (DM2). In that case the server (240) sends the new stored decoded message (DM2) to the client (230), the client (230) encodes the message to produce a new encoded message (M2) and sends the new encoded message (M2) to the server (240). The server (240) replaces in the database the stored encoded message (310) with the new stored encoded message (M2), and the stored decoded message (320) with the new stored decoded message (DM2). It is to be understood that in this embodiment, at no time does the client application (230) send the encryption key (232) to the server (240), and at no time does the server (240) have the key (232) in plain text form. In this way the system and method of the present invention is made secure against an attacker gaining access to the database of the server in as much as such an attacker would not thereby learn the key (232) and therefore not be enabled to decrypt information encrypted with the key (232).

In an embodiment of the present invention, the exchange of information between the server application (240) and the client application (230) can be conducted over a secure connection including but not limited to an SSL connection.

In accordance with an embodiment of the present invention, the encryption of the userid (255) and password (257) into an encrypted record is accomplished as follows. Note, in the following discussion the encrypted data is a single bitstream. It takes the place of the combination of the encrypted userid (245) and encrypted password (247) described herein. The following is pseudo-code for such an encryption, where U1 represents the master userid (210), and P1 the master password (220), URL_X the URL of the third party website (250), UX the userid for the third party website (255), and PX the password for the third party website (257).

```
FUNCTION ENCODE_U_P_URL( UX, PX, URL_X, U1, P1)
    STRINGX = UX + PX + URL_X;
    BITSX = HUFFMAN( STRINGX);
    BITSW = HASH( HUFFMAN( U1 + P1 + URL_X));
    BITSX = PAD_WITH_ZEROS( BITSX, 128);
    BITS = BITWISE_XOR( BITSX, BITSW);
    STORE_ON_SERVER( BITS, URL_X, U1);
END // END OF FUNCTION
```

The following is pseudo-code for the corresponding decryption, where again U1 represents the master userid (210), P1 the master password (220), and URL_X the URL of the third party website (250), UX the userid for the third party website (255), and PX the password for the third party website (257).

```
FUNCTION UX, PX = DECODE_U_P_URL(URL_X, U1, P1)
    BITS = GET_FROM_SERVER( URL_X, U1);
    BITSW = HASH( HUFFMAN( U1 + P1 + URL_X));
    BITSX = BITWISE_XOR( BITS, BITSW);
    STRINGX = INV_HUFFMAN( BITSX);
    UX, PX, URL_X2 = BREAK_STRING( STRINGX);
    ASSERT( URL_X == URL_X2);
END // END OF FUNCTION
```

Above HASH can be taken to be any appropriate hash function such as those known in the art, and in particular any encryption hash function such as SHA or MD5. For purposes of this discussion HASH will be taken to be a 128 bit hash function. The function PAD_WITH_ZEROS above is used to pad the Huffman coded bit sequence to 128 bits for compatibility with the function HASH. In the case where the resulting bit sequence has more than 128 bits, the sequence is broken into a list of 128 bit sequences, and each is encoded as above and stored (and then retrieved and decoded). In some embodiments the resulting bit sequences are pseudo-randomized in a predetermined way, after padding with zeros, to avoid so-called “weak encoding” attacks. When encoding multiple bit sequences, it is important to not use the same key, and so in that case BITSW can be replaced by: BITSW_I=HASH(HUFFMAN(U1+P1+NUM2STR(I)+URL_X)) (for I=1 to I_MAX==the # of 128 bit sequences to encode), and the above algorithm modified accordingly.

In an embodiment, the HUFFMAN function herein serves to pseudo-randomizes the bits of a bitstream in a reversible way, and it can be replaced by any predetermined function that accomplishes the same.

In some embodiments it is desirable to have an encryption or encoding that is expected to take a long time to decode. For example in authenticating a user to the website, or when storing a secure password recovery hint or deeply encrypted version of the master userid (210) and master password (220) as described elsewhere herein. In such cases the application of the HASH function can be iterated a predetermined fixed large number of times, thereby requiring the decoding algorithm to perform a similar iteration and therefore creating a reasonable certainty that the secure data can not be decoded rapidly. This is advantageous in that it further thwarts attackers wishing to gain access to the encrypted data. This is because a brute force attack requires a large number of trial decryptions and therefore becomes intractable when the individual trial decryption steps take a long time.

An alternate embodiment of the invention uses public-key cryptography as an alternative encryption. One embodiment uses the RSA algorithm for such a cryptography system (see http://en.wikipedia.org/wiki/RSA). To that end a hash code (H1) is created from the master userid (210) and master password (220) as described herein, for example by H1=HASH(HUFFMAN(U1+P1)). This hash code (H1) is used to seed a random number generator (RND). An RSA public-key (PUBi) and private-key (PRIVi) pair are generated using the random number generator (RND) immediately after seeding with the hash code (H1), so that the same key pair can be consistently generated on different runs, provided only that the same data of the master userid (210) and master password (220) are provided. When a user creates a new account on the website (240), such a key pair is created. The public key for the user is sent to the server (240) by the client application (230). The client application keeps the private key secret, and stores it only ephemerally (e.g. in RAM, and not on disk nor in any permanent database). The client application (230) is free to throw away the private key because the key can be regenerated algorithmically given the data of the master userid (210) and master password (220), which data is again not supplied to the server (240) nor is it stored in clear text in any permanent way but is remembered by the user. When the user wishes to use the website (240) at a later date, the user enters his master userid (210) and master password (220) into the client application. The client application (230) sends a request to the server (240) to log in or authenticate the user with the userid (210). The server retrieves from its database the public key (PUBi) associated with the userid (210), and uses it to encrypt a randomly selected message (RM1), sending the encrypted result (CM1) to the client (230). The client application (230) decodes the message (CM1) using the private key, to produce a decoded message (DMCL1), and sends the decoded message (DMCL1) to the server (240). The server (240) compares the received message (DMCL1) with the original randomly selected message (RM1). If the messages (DMCL1) and (RM1) are the same the user is authenticated and access to the server (240) proceeds as described herein, otherwise a failure response is sent back from the server (240) to the client application (230) and the user is informed by the client application (230) that authentication has failed and that the user should check his password and try again. The RSA key pairs are used by the client application (230) to encrypt userid (255) and password (257) combinations for third part websites (250), and these results are stored in the database of the server (240).

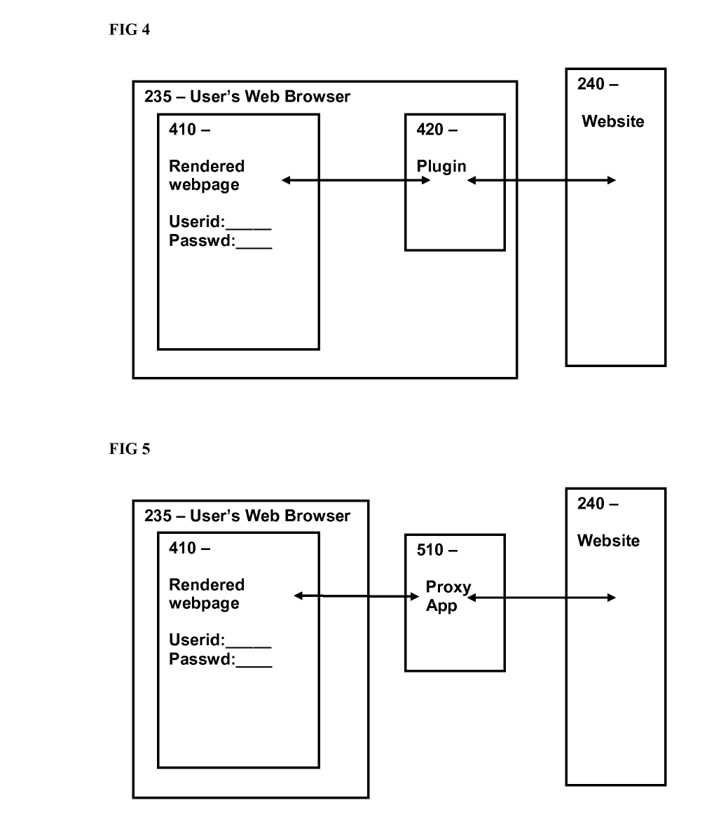

In an embodiment of the present invention, the client application automatically obtains the userid (255) and password (257) by intercepting these data from the user's interaction with the user's browser when these data (UX and PX) are entered (say for the first time, when the account is created, or when the user logs in to the account at some subsequent time), and/or inserts the decrypted userid (255) and password (257) by intercepting and filling in a web page/login form for the site X, when the web page is accessed by the user. In particular an embodiment comprises an interface for allowing the user to activate and deactivate this automated userid and password learning, a software component within the client application (230) that intercepts user-entered userids (255) and passwords (257), and a software component within the client application (230) that intercepts web pages requesting authentication, fills in the authentication data by first retrieving the data in accordance with an embodiment of the present invention and then filling in the authentication form or other authentication item, and sending the filled in data to the web site (250). This can be accomplished in an embodiment as depicted in FIG. 4 or FIG. 5.

FIG. 4 shows a plugin (420) that runs in the user's browser (235) and intercepts user/password interactions with web pages (410) such as account creation and login, in accordance with an embodiment of the present invention. The password interception can be accomplished either through a plugin or a built-in component of a browser or browser modified to work in accordance with an embodiment of the present invention. The intercepted passwords are then processed and used as described herein, to implement an embodiment of the present invention.

FIG. 5 shows a virtual proxy application, a portion of the client application in accordance with an embodiment of the present invention, which intercepts the user/password interactions as in FIG. 4. The user's browser (235) is configured to use a particular port on localhost as a proxy for all HTTP requests. The client application's proxy component (510) as disclosed herein listens on this port and acts as a web proxy, forward request to the Internet or to another proxy that the user wishes to use. When a webpage contains a user/password field, the URL is used to access the server (240) in accordance with an embodiment of the present invention, and if a userid/password for the webpage is available, it is automatically filled in. If one is not available, the user is prompted to create an account or notify the client application (230) of the userid/password, and (if successful) these data are stored on the server (240) in encrypted form in accordance with the techniques disclosed herein.

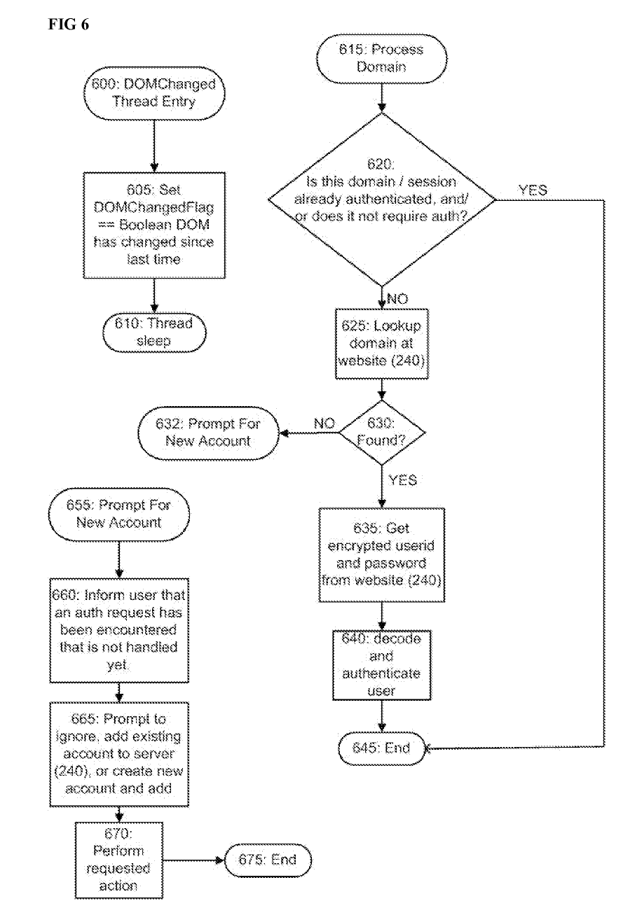

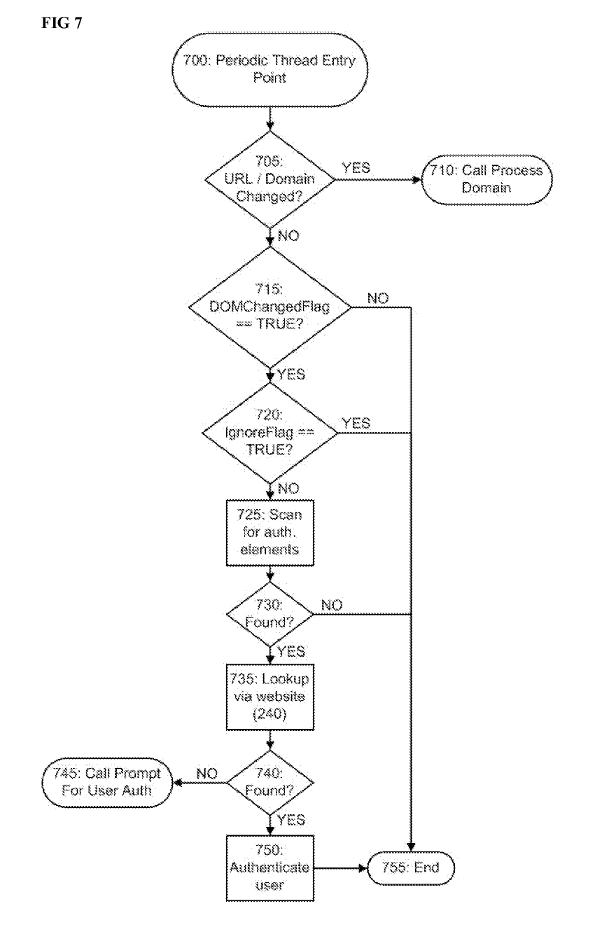

FIG. 6 and FIG. 7 show flow charts that comprise logic of the client application (230) in accordance with an embodiment of the present invention. An embodiment of the client application (230), for example in Javascript, comprises a thread or other object that sets a flag to true whenever the DOM (Document Object Model) of the content of the browser had changed (600, 605, and 610). A function to process the domain currently loaded into the content of the browser begins in step (615), tests whether the domain is presently authenticated, or if in fact no authentication is needed in step (620), if so the function exits. Otherwise, step (625) looks up the presently active domain via the website (240) (for example but not limited to the use of an AJAX query). If a record is not found for the domain, as tested in step (630), the function exits in step (632) by calling the “Prompt For New Account” function. Otherwise, in step (635), an encrypted form of the userid (255) and of the password (257) for the active domain are fetched from the website (240). Then, in step (640) these are decoded by the client application (230) as described herein, and the user is authenticated. The function then terminates in step (645).

The “Prompt For New Account” function in accordance with and embodiment of the present invention begins in step (655). The user is informed that an authorization request has been encountered that is not presently being handled by the website (240), in step (660). In step (665), the user is prompted with choices to ignore this site (in which case an IgnoreFlag is set to TRUE—and this flag is always cleared when the browser leaves the webpage), or to add an account to the website (240), that the user presently has with the currently active website, in which case, in step (670) the user enters this userid (255) and password (257), the client application (230) encrypts these and stores them on the server (240) as described herein, or finally in step (665) the user can opt to create a new account for the presently active site, in which case, in step (670) the user enters a new userid (255) and password (257), the client application (230) encrypts these and stores them on the server (240) as described herein. In each case the function ends at step (675).

An embodiment of the present invention comprises a Javascript program with a periodically executed function or thread comprising the steps shown in FIG. 7 which begin in step (700). In step (705) a test is made whether the URL/Domain has changed in the browser (240) since the last time this thread was run. If so, the “Process Domain” function is called. Otherwise, in step (715) the DOMChangeFlag is tested. If it is FALSE, the function exits in step (755). Otherwise in step (720) the IgnoreFlag is tested. If it is TRUE the function exits in step (755). Otherwise in step (725) the current web document's contents are scanned for authentication elements such as, but not limited to forms with fields of type “password”. If none are found the function exits in step (755). Otherwise in step (735) the present domain and present 3^{rd} party website is looked up in the server website (240). If it is not found then the function exits in step (745) by calling a “Prompt For User Authentication” function (not shown, but the same as the prompting and actions in steps (665) and (670)), otherwise, in step (750) the user is authenticated and the function exits in step (755). This function can be run, for example, every second or two by using a Javascript timer. The functions shown can be implemented using other scripting languages, or browser extensions, and Javascript is simply one example.

An embodiment of the present invention comprises the client application (230) described herein, incorporated into the website software of an Internet service provider, or embedded into an internet access device including but not limited to a modem, cable modem, DSL modem or the like. In this case all of the functions described for the client application are handled, for example, by a web proxy running inside the Internet service provider's site or in the modem. The website (240) functions in connection with such an embodiment as described herein.

An embodiment of the present invention comprises the client application (230) described herein, implemented as a browser in a browser. In this context a “browser in a browser” comprises a software function that runs in a browser, for example a so-called Web2.0 AJAX application, and that provides the functionality of a mini browser (BROWSER2) within the main browser (240). To that end, the mini browser (BROWSER2) then clearly has the capability to monitor authentication requests, and to insert userid's and passwords into the forms and other authentication mechanisms of the webpages it displays, as described herein. It is therefore to be understood that this browser in a browser AJAX component can take the place of the plugin or the proxy components shown in FIGS. 4 and 5, as described.

In accordance with an embodiment of the present invention, the website (240) comprises a webpage that causes the browser (235) to display for the user of a list of accounts to which the user belongs, providing a portal for the user to access all of the user's accounts from one place. This website can contain further components to manage these accounts, e.g., by drag and drop functionality, text entry, tagging, etc. For example, users can be given the ability to view the accounts sorted alphabetically, by subject, and by most frequently visited. A graphical element allows the user to turn the capture manager on and off. When it is on, then a function such as the “Periodic Thread” function (700) runs periodically. When it is off, the function does not run. This has the effect of the user being able to control whether the method and system of the present invention actively intercepts new passwords or not. The website also has a list of the top 10 (or, some other number) sites visited by the user. The webpage also displays advertisements that can be chosen in accordance with the methods described herein. The website also has a navigation menu to let users view a homepage, the user's profile, reports on usage, sending of feedback, login and logout, and links to any other tools of use in connection with the website (240). The webpage comprises elements that allow the user to tag or label the user's sites that are being managed by the website server (240), and so that they can be arranged, viewed, and managed by type, tag and/or keyword. The webpage additionally comprises a navigation element to bring up the browser in a browser described herein.

In accordance with an embodiment of the present invention, advertisements are displayed along with other content, contextualized to the information in a user's profile including but not limited to knowledge about sites that the user frequents or joins, frequency and co-occurrence of visits, and key words extracted from web surfing of the user through use of the server (240).

In an embodiment of the present invention, the website (240) can also store and provide access to the user's “favorites” or “Internet shortcuts”, in combination with the password management features disclosed herein. This combination provides a one-stop solution for the management of all of the user's web destinations whether these require authentication or not.

An embodiment of the present invention is additionally comprised of an advertisement section. In such a section, advertisements and/or other affiliate or paid links, banners, images, messages or other content are displayed. Since the website (240) has information that imparts knowledge of certain website memberships of the user, and frequency of usage, these advertisements, etc, can be targeted to the user profile. An embodiment for such targeting can include a user profile, a relevance statistical calculation, and price or bidding information for a set of advertisements. When certain events occur relating to the use of the website (240), advertisements are selected for display according to the relevance and the price or bid price, and the selected advertisements are displayed. Systems for accomplishing advertisement relevance and advertisement commerce can be used as described in conjunction with and in accordance with the present invention.

In accordance with an embodiment of the present invention, the kinds of statistics disclosed can also be provided as a service to businesses such as online retailers, in conjunction with the provisioning to consumers and users, of the products and services disclosed herein. Again the website (240) has information that imparts knowledge of certain website memberships of the user, and frequency of usage, perhaps also the purchase history of the user. These and other similar data, in short, will be called the user's profile herein. In accordance with an embodiment of the present invention, the user's profile is used as an independent vector-valued variable and a model is built using statistical techniques, such as but not limited to regression, to predict from this data, the probability that the user will purchase a given item at a given time.

An embodiment in accordance with the present invention is as follows. A given retailer's website (R) is provided with a landing page (L) that displays one or more advertisements for products of (R). When a user arrives at the page (L), if that user is a member of the website (240), a prediction is made as disclosed herein, of the probability that the user has an interest in each of the products of (R). Assuming that there are N spaces for ads on the page (L), the top/N most likely products are the ones chosen for display in the N slots of (L).

In an embodiment, the present invention comprises a component for single password sign on for systems that are not always connected to the Internet. The embodiment comprises a client application (230) that includes an encrypted data set, as disclosed herein, that when decrypted with the user's password provides the userid and password needed to connect the computer to the Internet (e.g. via a dialer, a DSL PPPoE app, or other similar application). Once connected, the same master userid (210) and master password (220) is used to connect to the website (240) and can then access all of the other sites as disclosed herein.

In some embodiments the present invention further comprises centralized and/or semi-automated account administration functions such as a password recovery system. The latter can be accomplished, for example but not limited to by having a predetermined secret question, plus the answer to the question (e.g. pet's name, mother's maiden name), and storing, e.g., the pair comprising the master userid (210) and master password (220) encrypted by a key built from the secret question+answer via the HASH, etc, algorithms disclosed herein or any similar algorithm. Additional functions from this centralized server include but are not limited to password resets of other kinds, account management and provisioning, and automatic or assisted client software updates.

Another aspect of the present invention relates to password resetting. In one regard this relates to the fact that when one has to remember a large number of account IDs and passwords, these are frequently lost or forgotten. In that case the user must go to the third party website (250) and request a “password ID reset”. With the present invention, when a user is a member of the third party website (250) through usage of the website (240) in accordance with the present invention, it is unnecessary for the third party website (250) to manage these password ID resets. Therefore a way to practice the present invention, in an aspect, is to provide the method, system and service of managed password ID resets. Therefore, in accordance with an embodiment of the present invention, the website (240) of the present invention can be comprised of a software component for password ID reset of one or more accounts. Additionally with respect to this component, when a user believes that the user's security may have been compromised for some reason, if the user manages the user's accounts through the website (240) of the present invention, the user can reset all IDs and passwords with a single request to the website (240).

Another aspect of password ID reset relates to the resetting of the master userid (210) and master password (220). In an embodiment of the present invention, users do not need to remember the list if userids and passwords required to access third party websites that are being managed by the website server (240). However, the users do need to remember one userid/password pair—the master userid (210) and master password (220). Security is accomplished in part, in an embodiment of the present invention, by not storing the master password (220) on the server (240), so that if an intruder were to gain access to the server (240), the intruder would not be enabled to decode the encrypted passwords stored, or partially stored, in the database of the website server (240). However, it is sometimes helpful to be able to remind a user of his master password (220) if he looses or forgets this password. In accordance with an embodiment of the present invention, there is a tradeoff of convenience vs. security that is offered to the user, providing a scale of options from most secure to most convenient. Option 1—the master password (220) is not stored in any way on the server (240). This is the most secure option, but if the user were to loose his master password (220), all other accounts would be temporarily lost, and each account's password (257) would need to be reset by an optional software component in the client application (230) or the server (240), in accordance with an embodiment of the present invention. Option 2—a copy of the master password is encrypted, printed on hard copy, and locked in a safe. This option is less secure but still allows for tight control and a manual master password recovery. Option 3—a copy of the master password is encrypted with an encryption algorithm so that it would take several minutes to decrypt on available hardware (or some other predetermined long amount of time), and this encrypted form is stored on a server. Option 4—a series of “Secret questions” are provided to the user, and the answers to these questions are used to encrypt a copy of the password (220), or perhaps to encrypt a second copy of the data in the database. In this way, one who has an answer to these questions can recover the password (220), but if the master password (220) and these answers are lost, then the data are lost and must be recovered as in option 1. Any of the options 2-4 can be combined with communication via a pre-specified email address belonging to the user, providing further proof that a requester of a password reset is the user in question.

One aspect of the present invention relates to provisioning of, or providing user accounts. To that end information about the user, stored in a user profile on the website server (240), are used to select and recommend a set of websites (SETX) to which the user might enjoy membership. The user profile data comprises one or more of demographic and other characteristic data about the user provided voluntarily by the user, deduced about the user for example in connection with usage of the services of the present invention, and/or purchased from third-party information providers. Examples include age, gender, zip code and other location information, topics of interest, co-occurrence of memberships in other websites, frequency of visits of particular websites, and online purchase history, to name a few. Similarly, the web server (240) has stored a database of profile information about third party websites. This information for a particular website (250) comprises one or more of: keywords about the website (250), demographic and/or other statistics and profile information about the users of the website (250), and amounts paid to the provisioning service provider in connection with placement on the list of sites in the set of websites (SETX). In order to provision new accounts, the website server application (240) computes a score of interest for a given user, for each of a set of websites for which website profile information is present in the database. The score comprises a numerical measure of the fit between the site and the user based on the information, and can be sorted according to the degree of fit, and also optionally in relation to an amount paid by the third party websites to influence the position on the list. The set of websites (SETX) comprises websites that have a score above a predetermined threshold, or the sites within the top N scores for some predetermined value N. A list of proposed accounts is displayed to the user and optionally the user can edit the list. Then accounts are created by automatic generation userid's and passwords in accordance with an embodiment of the present invention, and by the client application (230) logging in to create an account on each website from the set of websites (SETX). For each website in the set (SETX), the userid (255) and password (257), and other data in accordance with the present invention is stored in the database of the website server (240).

In this regard, a targeted website (W2) can be created in accordance with an embodiment of the present invention to provision accounts for members of a particular demographic or affinity group and to provide access aggregation as described herein. For example, one embodiment comprises a website and client application for children in which new members are provided with accounts to a variety of age-appropriate and relevant websites, and the passwords are automatically managed in accordance with the method and system disclosed herein. A user interface can be provided, for example with large colorful buttons, so that children can easily recognize the websites that they use, and click on the large buttons without the need for the dexterity, spelling skills, and ability to remember and mange account IDs and passwords that would otherwise be required when using prior art methods of access to websites.

Another embodiment comprises a method and system for managing and aggregating access and account credentials for websites that are not of a nature to handle financial information such as bank accounts, investments, credit cards and the like. In this way a simplification arises in the nature of the security problem for password management and protection. To that end, the website (240) can additionally comprise a list of websites that are explicitly allowed under the embodiment (a “whitelist”) comprised of websites known to be of a non-financial nature such as social networking, music and entertainment websites and the like, and a list of websites that are explicitly not allowed under the embodiment (a “blacklist”) comprised of websites known to be the websites of banks, investment firms, credit cards companies and the like.

In another embodiment passwords are generated by a client application rather than being stored in encrypted form. In accordance with this embodiment, a cryptographically strong hash function is applied to UX, URL_X, U1 (the master userid (210)), KX and P1 (the master password (220)) to generate a pseudo-random bit sequence of a predetermined length. Here KX is additional data that allows the user to change the password PX from time to time, without the need to change U1 and P1. A custom function, depending on the password rules for the target website, is applied to the result to produce a password PX that meets the requirements for the website (i.e. there can be required a certain number of letters, numbers, caps and lowercase, punctuation, etc; it may also be required not to repeat prior passwords, or to change passwords regularly, each of which can be controlled via KX. KX is not critical to password security and hence can be stored on the client and/or the server).

In psedo-code:

```
FUNCTION PX = GENERATE_P_URL( UX, URL_X, KX, U1, P1)
    STRINGX = UX + URL_X;
    BITSW = HASH( PREPROCESS( U1 + P1 + UX+URL_X));
    PX = CUSTOM_FUCNTION (BITSW);
    RETURN PX;
END // END OF FUNCTION
```

In another aspect of access, sometimes a user needs to know that he is actually connected to a particular destination such as a website or connection portal, and not, for example, to a malicious “middle man” attacker, “phisher” or other spoofed site, login screen or portal. In this regard, in accordance with an embodiment of the present invention, the client application can be equipped with a challenge-response or public-key/private-key component to insure security in this sense. In one such embodiment, the client application contains a copy of a public key, from a public key/private key pair such as in the RSA security system, an encoded and spontaneously generated message is sent by the client to the server which only the true server can decrypt, and the server sends back a response based on and determined by the message sent, in order to prove that the server was able to decrypt the message. In this way it is possible to prove that the connection is to the endpoints of the client and the true server, without reverse engineering of the client being helpful in breaking this authentication scheme. Additionally, statistics of the connection speed and number hops can be encoded into the messages exchanged, to prevent middle man attacks that effect network topology or packet statistics or timing.

An embodiment of the present invention for use by a company to manage information technology (IT) needs for the company is comprised of a central account administration program that comprises functions to key in or import lists of user identities, groups and applications, to accept the defaults, and/or define custom rules for access, password policies, and maintenance, to generate initial rollout packages which are automatically emailed to the population of users with one click, and a daily administration interface comprising function by which IT personnel can check daily usage statistics and policy compliance, add and remove users, and perform special tasks such as security lockdowns. Business users of this embodiment install a program on their computers, and once installed, this program can launch, for example right along with the user's operating system, and can appear, for example, as an icon in the system tray. Accounts are provisioned centrally as described, and automatically sent to the program so the user's do not need to keep separate credentials to access the various corporate applications needed. The icon in the system tray can change colors to signify that the user can simply access applications and have the authentication done automatically. This allows for automatic enforcement of corporate security policies such as the use of strong passwords, periodic changing of passwords and the centralized management of group and individual access policies.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed:

1. A computer based method for authentication of a user of products and services over a network, said authentication comprising a first userid and a first password said method comprising the steps:
Accepting a master userid and master password from said user,
Creating an encryption key from said master userid and said master password,
Receiving said first userid and said first password,
Encrypting said first userid and first password using said encryption key, to produce encrypted information,
Sending said encrypted information to a server for storage,
Retrieving said encrypted information from said server,
Decrypting said encrypted information to produce a decrypted information, and,
Authenticating said user using said decrypted information.

2. The method of claim 1 wherein the step of receiving said first userid and said first password comprises retrieving said first userid and said first password from data entered into an authentication web form, thereby providing an automated system not requiring an extra step for the user.

3. The method of claim 1 wherein the step of authentication said user using said decrypted information comprises inserting said first userid and said first password into an authentication web form, thereby providing an automated system not requiring an extra step for the user.

4. The method of claim 1 wherein the step of creating an encryption key from said master userid and said master password comprises a hash function.

5. The method of claim 1 wherein the step of creating an encryption key from said master userid and said master password comprises the generation of a pseudo-random prime number.

6. A system for authentication of a user of products and services over a network, said authentication comprising a first userid and a first password, said system comprising:
A client application, and
A server application, wherein
Said client application is disposed to accept a master userid and master password from said user, to create an encryption key from a hash function of said master userid and said master password, to receive said first userid and said first password, to encrypt said first userid and first password using said encryption key, to produce encrypted information, to send said encrypted information to said server for storage, to retrieving said encrypted information from said server, to decrypt said encrypted information to produce a decrypted information, and to authenticate said user using said decrypted information.

7. The system of claim 6 further comprising a browser plugin wherein said client application is incorporated into said browser plugin and is thereby disposed to automatically authenticate said user.

8. The system of claim 6 further comprising a web proxy wherein said client application is incorporated into said web proxy and is thereby disposed to automatically authenticate said user.

9. The system of claim 6 further comprising a modem wherein said client application is incorporated into said modem and is thereby disposed to automatically authenticate said user.

10. The system of claim 6 further comprising a browser in a browser software component wherein said client application is incorporated into said browser in a browser software component and is thereby disposed to automatically authenticate said user.

11. The system of claim 6 wherein the client application further comprises a periodically executed function that checks for authentication requests, thereby providing an automated system not requiring an extra step for the user.

12. A method of providing a set membership accounts to a first set of websites, for a user, said set first of websites selected from a second set of websites, said method comprising
Receiving information about said user,
Receiving information about each website of said second set of websites,
Comparing said information about the user to said information about each website of said second set of websites to produce a score for each website of said second set of websites,
Selecting said first set of websites to be a predetermined number of websites from said second set of websites with the highest said scores,
Creating a membership account comprising authentication information for said user to access each website from said first set of websites,
Encrypting said authentication information to produce encrypted authentication information, and
Sending said encrypted authentication information to a server for storage and later retrieval.

13. The method of claim 12 wherein the step of receiving information about each website of said second set of websites comprises receiving an amount paid for placement of said each website.

14. The method of claim 12 wherein said step of receiving information about said user comprises receiving the age, gender or residence location of the user

15. The method of claim 12 wherein said step of receiving information about said user comprises receiving information about membership of said user in an affinity group
